(19) United States
(12) Patent Application Publication
(10) Pub. No.: US 2009/0124186 A1
(43) Pub. Date: May 14, 2009

(54) INSTALLATION FOR SPLITTING HOG CARCASSES OR EQUIVALENT COMPRISING ONE OR MORE ROBOTS

(75) Inventor: Nicolas Klein, Loriol Sur Drome (FR)

Correspondence Address: HARNESS, DICKEY & PIERCE, P.L.C., P.O. BOX 828, BLOOMFIELD HILLS, MI, 48303, US

(73) Assignee: Durand International, Baix (FR)

(21) Appl. No.: 12/265,266

(22) Filed: Nov. 5, 2008

(30) Foreign Application Priority Data
Nov. 12, 2007 (FR) 0707905

(51) Int. Cl. A22B 5/20; A22B 5/00; A22C 17/00

(52) U.S. Cl. 452/152; 452/149

(57) ABSTRACT

The installation for splitting hog carcasses or equivalent, comprises support means (1) for carcasses having components (2) for suspending carcasses, a splitting tool (4) supported by a splitting head (5), displaced in a splitting plane, a dorsal support device (6) and a ventral support device (7), suitable for being displaced in the splitting plane and for providing a fixed and predetermined relative positioning of the carcass in relation to the splitting plane, support means for the splitting head (5), support means for the dorsal support device (6) and for the ventral support device (7), motor means for displacing the splitting tool (4), means for displacing the splitting head (5), means for displacing the dorsal support device (6) and the ventral support device (7), control means, and at least one robot (8, 9, 16), supporting at least one portion of the support means for the splitting head (5), of the support means for the dorsal support device (6) and of the support means for the ventral support device (7), and constituting at least in part means for displacing the means that same supports: a splitting head (5), a dorsal support device (6) and ventral support device (7).

### CROSS-REFERENCE TO RELATED APPLICATIONS

This application claims priority to French Application No. 0707905, filed Nov. 12, 2007; which is incorporated by reference herein.

### BACKGROUND AND SUMMARY

The invention relates to an installation for splitting hog carcasses or equivalent.

Various embodiments of hog carcass splitting installations are already known. In some embodiments, the installation comprises a circular saw blade and in others knives. According to the designs, either the carcass is attached or it is driven in displacement by a conveyor during the splitting operation. Either the installation is located on one side only of the displacement plane of the carcasses or it is located on both sides. In this latter case, either the installation comprises two structurally different functional assemblies or they are rigidly connected together. According to the cases, either the carcass is totally split to produce two separate half-carcasses or it is only split partially the two portions obtained by splitting remaining connected to one another in a portion not sawn located in the region of the spine (this cut is known under the expression of “American cut”), or even in the middle of the back.

An embodiment of an installation for splitting hog carcasses is described for example in document EP-A-1 125 502. Such an installation comprises:

support means for carcasses, including components for suspending the carcasses,

a frame comprising two vertical columns located on either side of the vertical displacement plane of the carcasses,

a saw blade, supported by a saw head, suitable for being rendered operational and displaced in the vertical median plane of the carcass to be sawn,

a dorsal support device and a ventral support device, opposite one another and located substantially on either side of the displacement plane of the carcasses, suitable for being displaced during the sawing in the sawing plane and for providing a fixed and predetermined relative positioning of the carcass during the sawing in relation to the sawing plane,

support means for the saw head, i.e. a carriage supported by one of the columns of the frame by means of other carriages, the combination of carriages—and of the motion thereof—enabling the saw blade to be positioned in any desired location,

support means for the dorsal support device and support means for the ventral support device, i.e. carriages, supported, the first, by the other of the columns of the frame, by means of other carriages, and the second by the support carriage of the saw head,

motor means for the saw blade in order to render same operational,

means for displacing the saw head,

means for displacing the dorsal support device and means for displacing the ventral support device, i.e. respective sliding means combined with respective driving means,

means for controlling the motor means of the saw blade, means for displacing the saw head, means for displacing the dorsal support device, means for displacing the ventral support device, according to coordinated displacements to provide the sawing of the successive carcasses in the median planes thereof according to successive sawing cycles.

With such an installation, there are numerous mechanical means, each of them providing a specific function: support, sliding (or guiding), driving. The installation is therefore heavy and bulky. The replacement of such or such a component requires time. Finally, the cleaning thereof is rendered complex.

Document U.S. Pat. No. 4,653,150 describes a carcass splitting device which comprises

support means for carcasses, including components for suspending the carcasses,

a mobile frame comprising two vertical columns located on either side of the vertical displacement plane of the carcasses,

a saw blade, supported by one of the two columns,

and a dorsal support device, supported by the other of the two columns.

Document EP-A-0801900 describes a dorsal guiding device and method for splitting a meat-producing animal carcass. The devices or installations which have just been described are certainly automatic mechanised systems that are suitable for performing several tasks, in a given environment, autonomously, via the execution of a program, in as much as, they may not be qualified as industrial robots within the meaning commonly given to that expression in industrial environments, as it will be disclosed by the following.

Document WO 2006/063744 describes a carcass cutting system and method, comprising a stationary cutting robot, to which is combined a surface for supporting the carcasses and press means slidably mounted along this support surface. Said method and said system do not benefit from the advantages offered by automation, same being only very partial. Document WO 2007/122244 describes a carcass cutting method implementing a saw holder robot. As aforementioned, said method does not benefit from the advantages offered by automation, the same being only very partial.

Document EP-A-1 263 292 describes a carcass cutting device which comprises a cutter supported by a robotized arm controlled by a computer coupled to an optical system. Said device is not intended for splitting carcasses. Furthermore, it poses the problem that the carcass treated is not individually and accurately retained but only pressed against a wall. An equivalent arrangement is described in documents WO 2006/063744 and U.S. Pat. No. 4,667,371. Document EP-A-0 494 935 describes a method and a device for separating a material of relatively weak structure from a material of relatively robust structure using a cutting component controlled by a robot. Said method and said device does not permit the splitting of carcasses. Documents EP-A-1010499 and EP-A-1880809 describe, that which is commonly meant in industrial environments by “robot”. This does not mean any automatic mechanised system able to perform one or more tasks, in a given environment, autonomously, via the execution of a program, as a robot is often defined but an industrial device suitable for producing an operational task in response to an instruction which is given to same, comprising a base and, mounted on same with at least one degree of rotation, a succession of arms terminated by a hand, hinged to one another and to which are associated driving means, the hand being suitable for being displaced according to a predetermined or predeterminable path, for transmitting a force, and for being equipped with a dedicated work device. It is in reference to this second definition that the word “robot” is used herein.

A need exists for an installation for splitting carcasses which is less heavy and bulky than the known installations, which enables such or such a component to be replaced within a limited time, the cleaning of which is easy and effective, which provides effective retaining of the carcasses so that the splitting is of quality and without loss, finally which can make the most of the advantages offered by automation, within the above defined meaning. To this effect, the invention proposes an installation for splitting hog carcasses C or equivalent comprising:

support means for carcasses C before the splitting, during the splitting, and after the splitting, comprising components for suspending the carcasses C,

a splitting tool for carcasses C, supported by a splitting head, suitable for being rendered operational and displaced in a splitting plane at least substantially vertical and median of the carcass during the splitting, arranged at least substantially perpendicular to a plane at least substantially vertical of relative displacement in translation of the carcasses C at least before and after the splitting passing through the component for suspending the carcass during the splitting, the displacement plane of the carcasses C and the component for suspending the carcasses C defining a line of displacement of the carcasses C at least substantially horizontal,

a dorsal support device and a ventral support device, opposite one another and located substantially on either side of the displacement plane of the carcasses C, suitable for being displaced during the splitting in the splitting plane and for providing a fixed and predetermined relative displacement of the carcass during the splitting in relation to the splitting plane,

support means for the splitting head,

support means for the dorsal support device and support means for the ventral support device,

motor means for the splitting tool to render same operational in the splitting plane,

means for displacing the splitting head,

means for displacing the dorsal support device and means for displacing the ventral support device,

means for controlling the motor means of the splitting tool, means for displacing the splitting head, means for displacing the dorsal support device, means for displacing the ventral support device, in a coordinated way to provide the splitting of the successive carcasses C in the respective median planes thereof, according to successive splitting cycles,

characterised by at least one robot, i.e. an industrial device suitable for producing an operational task in response to an instruction which is given to same, comprising a base and, mounted on same with at least one degree of rotation, a succession of arms terminated by a hand, hinged to one another and to which are associated driving means, the hand being suitable for being displaced according to a predetermined or predeterminable path, for transmitting a force, and for being equipped with a dedicated work device:

supporting at least one portion of the support means for the splitting head, of the support means for the dorsal support device and of the support means for the ventral support device,

and constituting at least in part the means for displacing the means that same supports: a splitting head, a dorsal support device and ventral support device.

According to one embodiment, the support means for the splitting head, the support means for the dorsal support device and the support means for the ventral support device are all supported by at least one robot constituting the means for displacing the splitting head, the dorsal support device and the ventral support device. According to a feature of the invention, the installation is free of columns forming the frame, carriages supported by such columns and driving and guiding components associated to such carriages, such as same known from prior art.

According to one embodiment, the installation comprises two robots, i.e.:

a first robot supporting the support means for the splitting head and the support means for the ventral support device, and moreover constituting the means for displacing the splitting head and the ventral support device,

a second robot supporting the support means of the dorsal support device, and moreover constituting the means for displacing the dorsal support device

the two robots being located opposite one another, on either side of the displacement plane of the carcasses C, and separated by a free space enabling the carcasses C to pass between same.

According to a second embodiment, the installation comprises a single robot supporting the support means for the splitting head, the support means for the dorsal support device and the support means for the ventral support device, said robot moreover constituting the means for displacing the splitting head, the dorsal support device and the ventral support device, said robot being laterally offset in relation to the displacement plane of the carcasses C to enable the carcasses C to pass therethrough. According to one embodiment, a robot is of the six-axes type.

According to a first embodiment, firstly a stationary robot or robots are provided, a substantial portion of which at least the displacements takes place at least substantially in the splitting plane forming at least substantially a median plane for the robot or robots, and secondly control means are provided suitable for controlling the components for suspending the carcasses C so that, during the splitting, they remain in the stationary state. According to a second embodiment, firstly a stationary robot or robots are provided a portion of the displacements of which takes place at least substantially in the splitting plane and a portion outside of same, and secondly control means are provided suitable for controlling the robot or robots and the components for suspending the carcasses C so that, during the splitting, the latter are displaced in translation along the line of displacement and in the displacement plane of the carcasses C, in synchronism with the robot or robots such that the splitting head and the carcass are located in the splitting plane. According to a third embodiment, a robot or robots are provided supported by a table or tables slidably mounted at least substantially horizontally at least substantially parallel to the line of displacement of the carcasses C, as well as means for displacing the components for suspending the carcasses C along the line of displacement of the carcasses C and in the displacement plane of the carcasses C, the control means being suitable for controlling in synchronism the components for suspending the carcasses C and the table or tables so that they remain opposite, without substantial offset parallel to the line of displacement of the carcasses C, at least during the splitting.

According to one embodiment, the installation also comprises a cleaning device or devices, such as boxes, wherein the robot or robots can insert the means that they support in view of the cleaning thereof. According to one embodiment, a robot is provided with deformable means for protecting against dirt, such as a sheath, a cover or equivalent.

According to one embodiment, the installation comprises a dorsal support device and/or a ventral support device arranged at least substantially in the vicinity of the splitting plane and comprising a plurality of guiding components, such as rollers, spaced apart from one another at least substantially parallel to the line of displacement of the carcasses C, and located on either side of the splitting plane, in the vicinity, in particular immediate, of the splitting tool. According to one embodiment, for the dorsal support device and/or for the ventral support device, the guiding components are arranged in a pair of components spaced apart from one another by a small space, along a direction at least substantially vertical. According to another first embodiment, a robot supports the splitting head which itself supports the ventral support device located below. According to a second embodiment, a robot distinctly supports the splitting head and the ventral support device, located below the splitting head.

According to one embodiment, displacement means are provided relating to translation over a short distance of the splitting head and of the ventral support device in relation to a line at least substantially horizontal located in the splitting plane, the control means also acting on said displacement means. According to one embodiment, suitable mobile or releasable means are provided for protecting the splitting tool so that the portion being able to interfere with the hams of the carcass C is first rendered inoperable at the latest before the splitting tool interferes with the carcass C and, then, rendered operational for splitting the carcass C strictly speaking. According to two possible embodiments, the means for controlling the motor means of the splitting tool, means for displacing the splitting head, means for displacing the dorsal support device, means for displacing the ventral support device, are programmed to provide either the total splitting or the partial splitting of the successive carcasses C in the respective median planes thereof. According to the embodiments, the splitting tool is of the circular saw blade type pivotably mounted about the axis thereof or of the knife or set of knives type pivotably mounted alternatively over a certain distance.

### BRIEF DESCRIPTION OF THE DRAWINGS

The invention will be well understood from reading the following description of a plurality of executions and embodiments, in reference to the following figures:

FIG. 1 is a schematic perspective view, of the ventral side of the carcass, of a first possible embodiment of the installation in the case where it comprises two stationary robots, the splitting tool, the ventral support device and the dorsal support device being in situation for starting the splitting of a carcass to be split being located in the installation;

FIG. 2 is a schematic view equivalent to FIG. 1, of a second possible embodiment of the installation in the case where it comprises two robots supported by a table horizontally slidably mounted parallel to the means supporting the carcasses C;

FIG. 3 is a schematic view equivalent to FIGS. 1 and 2, of a third possible embodiment of the installation in the case where it comprises a stationary robot; and

FIG. 4 is a schematic view equivalent to FIGS. 1 to 3 of a fourth possible embodiment of the installation in the case where it comprises a robot supported by a table horizontally slidably mounted parallel to the means supporting the carcasses C.

### DETAILED DESCRIPTION

The description is made in reference to an installation “in situation”, i.e. capable of operating. Thus the words “vertical”, “horizontal”, “top”, “bottom” must be understood. It must also be understood that “vertical”, and “horizontal” targets at the same time everything that is strictly vertical or horizontal, respectively, and which is substantially this, even if said qualificative is not mentioned. In the description, the word “robot” designates an industrial device suitable for producing an operational task in response to an instruction which is given to same, comprising a base and, mounted on same with at least one degree of rotation, a succession of arms terminated by a hand, hinged to one another and to which are associated driving means, the hand being suitable for being displaced according to a predetermined or predeterminable path, for transmitting a force, and for being equipped with a dedicated work device.

Such an installation for splitting a hog carcass C comprises firstly support means 1 for carcasses C before the splitting, during the splitting, and after the splitting—total or partial according to the embodiments. “During the splitting” means the phase which comprises the splitting strictly speaking, but also the phase preparing the splitting strictly speaking and the phase following the splitting. The support means 1 for carcasses comprises components 2 for suspending the carcasses C, such that same, are arranged vertically rear legs at the top and head at the bottom. Said means 1 are placed at the top of the installation above the carcasses C. In one embodiment, the support means for the carcasses 1, also comprise means for displacing the components 2—and thus for driving the carcasses C—in a vertical displacement plane, along a line of displacement arranged horizontally.

If the invention applies most specifically to hog carcasses C, it can be transposed to equivalent animal carcasses C. This means animals the splitting of which is carried out in an equivalent way to that used for hogs. For example, it may concern calves. The word “frontal” refers to that which is close to or rotated towards the displacement plane of the carcasses C. The word “rear” refers to that which is, on the contrary, away from or rotated away from the displacement plane of the carcasses C. The word “transversal” refers to that which is arranged perpendicular to or substantially perpendicular to the displacement plane of the carcasses C. Finally, the words “dorsal” and “ventral” must be understood in relation with a carcass C.

The support means 1 for the carcasses are for example a conveyor such as a rail 3 supported by a superstructure, extending along the line of displacement, to which are suspended at regular intervals the suspension components 2 such as gambrels with two forks or equivalent means, intended for hooking the carcasses C by the rear legs, head downwards. A line of displacement D for the carcasses C is thus defined. The means for driving the suspension components 2 are for example an endless chain to which are hooked the suspension components 2, said chain being driven by a motor or a drive unit.

The installation comprises a tool 4 for splitting carcasses C, supported by a splitting head 5. The splitting tool 4 is, in the embodiments shown in the figures, a circular saw blade pivotably mounted about the axis thereof arranged parallel to the line of displacement D. The splitting tool 4 can, alternatively, be a knife or a set of knives pivotably mounted alternatively over a certain distance. The splitting tool 4 is suitable for being rendered operational in the vertical median plane of the carcass C, known as the splitting plane. “Operational” means the fact that the splitting tool 4 is able to provide the function thereof of splitting of the carcass C. Motor means are provided for this purpose, such as an electric motor or a drive unit incorporated into the splitting head 5, which enables the splitting tool 4 to be rotably driven in the case of a saw blade or alternatively in one direction and in the other over a certain distance of pivoting in the case of knives.

The splitting plane is arranged vertically, transversally. According to whether, during the splitting, the carcass C remains stationary or on the contrary is displaced in translation along the line of displacement D and in the displacement plane, the splitting plane is fixed or on the contrary is displaced in translation parallel to same and to the line of displacement D of the carcasses C. The splitting tool 4 is, also, suitable for being displaced—as a whole—in the splitting plane. For this, the splitting head 5 is displaced, the displacement thereof providing that of the splitting tool 4.

In one embodiment, mobile or releasable mechanical means are provided for protecting the splitting tool 4. Such protection means are suitable such that the portion of the splitting tool 4 that may interfere with the hams of the carcass C is first rendered inoperable at the latest before the splitting tool 4 interferes with the carcass C and, then, rendered operational for splitting the carcass C strictly speaking. Such a constructive arrangement enables the integrality of the hams, noble part of the carcass C to be preserved.

The installation also comprises a dorsal support device 6 and a ventral support device 7 on the carcass C. Said devices 6, 7, serve to exert on the carcass C specific forces to provide a relative correct, predetermined and fixed positioning of the carcass to be split C in relation to the splitting plane, during the splitting. In one embodiment, such dorsal support and ventral support devices are of the general type described in document EP-A-1 15 502, within the abilities of the person skilled in the art. The devices 6, 7 are arranged in or in the vicinity of the splitting plane, being opposite one another towards the displacement plane of the carcasses C, and substantially located on either side of said plane. The devices 6, 7 are suitable for being displaced during the splitting in the splitting plane, in order to provide the function thereof of positioning of the carcass C during the splitting. The displacement thereof is suitable for the type of splitting to be produced: total splitting or partial splitting.

In one embodiment, the dorsal support device 6 is located on the side opposite the splitting head 5 and the splitting tool 4. In said same embodiment, the ventral support device 7 is located on the same side as the splitting head 5 and the splitting tool 4. The notion of “same side” or “opposite side” means in relation to the displacement plane of the carcasses C. In one embodiment, the devices 6, 7 comprise a plurality of guiding components such as rollers rotably mounted, or fixed guides, intended for urging against the carcass C, respectively against which is urged the carcass C, with a certain pressure. Said guiding components are urged against the carcass on either side of the splitting plane and, as indicated, on either side of the displacement plane of the carcasses C. To this effect, in the embodiment considered herein, for device 6 and for device 7, the guiding components are arranged into a pair of components spaced slightly apart from one another parallel to the line of displacement of the carcasses C, and located, in the vicinity, in particular immediate, with the splitting tool 4, on either side of same. Said constructive arrangement is such that the guiding components tend to exert on the carcass C forces directed towards the splitting plane.

Furthermore, in the embodiment considered herein, and if necessary for device 6 as well as for device 7, the guiding components are also arranged into a pair of components spaced apart from one another along a vertical direction via a small space. Said constructive arrangement enables the guiding components to fit the shape of the carcass C during the splitting. With the arrangements that have just been described, each device 6, 7 comprises four rollers or guides. If necessary, other embodiments may be provided with a different number of rollers or guides.

The devices 6, 7 are suitable for being displaced, in their entirety, in the splitting plane, during the splitting, whilst remaining close to the splitting tool 4. When it is desired that the splitting tool 4 stops splitting the carcass C, as is the case for the so-called American cut, the devices 6, 7 are moved away from the splitting tool 4, respectively from the carcass C. More generally, the moment where on one hand device 6, on the other hand device 7 starts interfering with the carcass C, and the moment where same stops interfering with the carcass C, in relation to the moment where the splitting tool 4 starts and stops interfering with the carcass C, respectively, may be the subject matter of alternative embodiments, according to the splitting features desired.

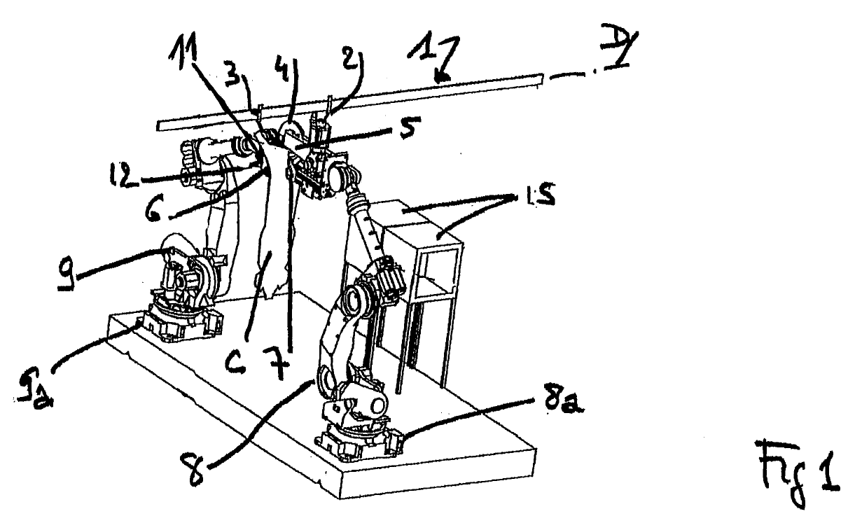

In the first embodiment (FIG. 1), the installation comprises a first robot or manipulator arm 8 and a second robot or manipulator arm 9 (later, only the term “robot” will be used for convenience). Said robots 8, 9 are located towards the bottom of the installation and are stationary, being attached to the ground S or on any equivalent suitable superstructure, by the rear and lower bases 8a, 9a thereof. The two robots 8, 9 are placed on either side of the displacement plane of the carcasses C and of the support means 1 of the carcasses C. They are located in the same transversal plane. They are spaced apart from one another by a distance enabling the carcasses C to pass between same. In one embodiment, the robots 8, 9 are of the type having six axes AA, BB, CC, DD, EE and FF. In addition, said robots are suitable for handling heavy loads.

The first robot 8 supports—and in part constitutes—the support means 10 for the splitting head 5 and the support means 11 for the ventral support device 7, positioned at the frontal end of the first robot 8, in the vicinity of one another. According to one embodiment, the first robot 8 supports the support means 10 for the splitting head 5 which itself supports the support means 11 for the ventral support device 7, located below the splitting head 5, in particular just below. In another embodiment, the first robot 8 which distinctly supports, separately, the support means 10 for the splitting head 5 and the support means 11 for the ventral support device 7, located as previously indicated.

In an embodiment compatible with one and the other of those which have just been described, displacement means are provided relating to translation over a short distance of the splitting head 5 and of the ventral support device 7 in relation to a transversally horizontal line located in the splitting plane. In this case, the control means of the installation are provided for also acting on said displacement means. Said arrangement is useful for adapting the force exerted by the ventral support device on the carcass C according to the necessities linked to the splitting. On the other hand, the first robot 8 constitutes the displacement means in the splitting plane of the splitting head 5, as well as the ventral support device 7.

The second robot 9 supports—and in part constitutes—the support means 12 for the dorsal support device 6. Furthermore, the second robot 9 constitutes the displacement means for the dorsal support device 6.

“The first robot 8 supports—and in part constitutes—the support means 10 for the splitting head 5 and the support means 11 for the ventral support device 7”, and “the second robot 9 supports—and in part constitutes—the support means 12 for the dorsal support device 6” means, the fact that the structure itself of the robot 8, 9 supports the splitting head 5, the ventral support device 7 or the dorsal support device 6, such that the installation is free of a column forming the frame, the carriage supported by such a column and the driving and guiding component associated to such a carriage, such as in the prior art illustrated by document EP-A-1 125 502.

The robots 8, 9 are provided frontally with components for attaching the means that they support. It may concern attachment plates with which the suitable immobilisation components engage. Furthermore, the robots 8, 9 are chosen and configured so that the means that they support can be located where necessary, with the essential movement distances.

The installation also comprises means for controlling the motor means of the splitting tool 4, means for displacing the splitting head 5, means for displacing the dorsal support device 6, means for displacing the ventral support device 7, and if necessary means for displacing the components 2 for suspending the carcasses C such as disclosed hereafter, according to the displacements coordinated for producing the total or partial splitting of the successive carcasses C, in the median planes thereof, according to the successive splitting cycles. In a first embodiment, a substantial portion at least of the displacements of the robots 8, 9, takes place in the splitting plane, which forms at least substantially a median plane of the robots. In this case, it is planned that the means for controlling the installation are suitable for controlling the components 2 for suspending the carcasses C so that, during the splitting, they remain in the stationary state. In a second embodiment, a portion of the displacements of the robots 8, 9, takes place in the splitting plane and a portion outside of same. In this case, the control means are arranged in order to be suitable for controlling the components 2 for suspending the carcasses C so that, during the splitting, they are displaced in translation along the line of displacement and in the displacement plane of the carcasses C.

In one embodiment, the installation also comprises a cleaning device or devices 15, such as boxes, wherein the robot or robots 8, 9 can insert the means that they support in view of the cleaning thereof: a cutting tool 4, components for guiding the dorsal 6 and ventral 7 support devices. Such cleaning takes place after a splitting or a series of splittings or at any desired time. In one embodiment, the robots 8, 9 are provided with means for protecting against dirt, said means being deformable according to the deformation of the robots 8,9, such as a sheath, a cover or equivalent. The control means are programmed to provide either the total splitting or the partial splitting of the successive carcasses C in the respective median planes thereof.

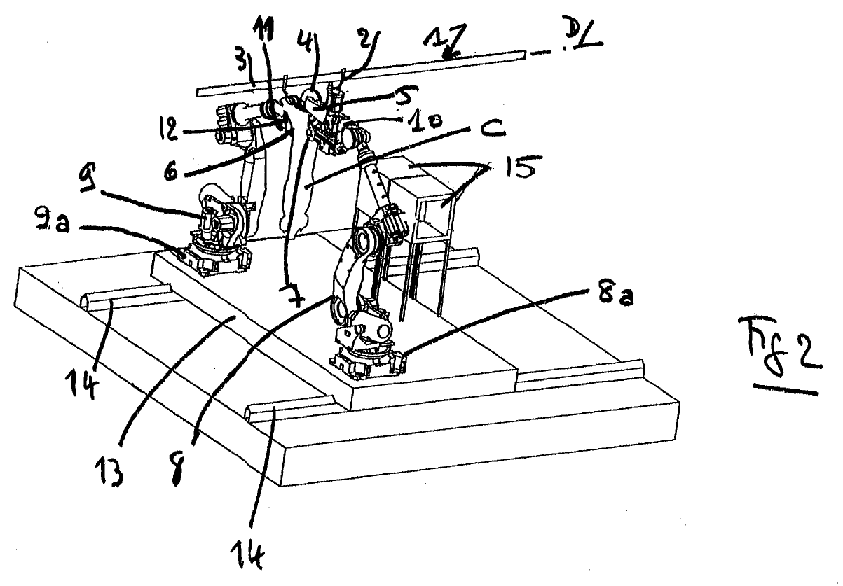

The second embodiment (FIG. 2) differs from the first in that the robots 8, 9 are not attached to the ground S, but supported by a table 13 horizontally slidably mounted parallel to the support means 1 of the carcasses C and to the line of displacement with the aid of rails 14 or equivalent attached to the ground S. If necessary, not one table but two separate tables are provided, one for each robot 8, 9. In this case, the control means are suitable for controlling in synchronism the components 2 for suspending the carcasses C and the table or tables 13 so that they remain opposite, without substantial offset parallel to the line of displacement of the carcasses C, at least during the splitting.

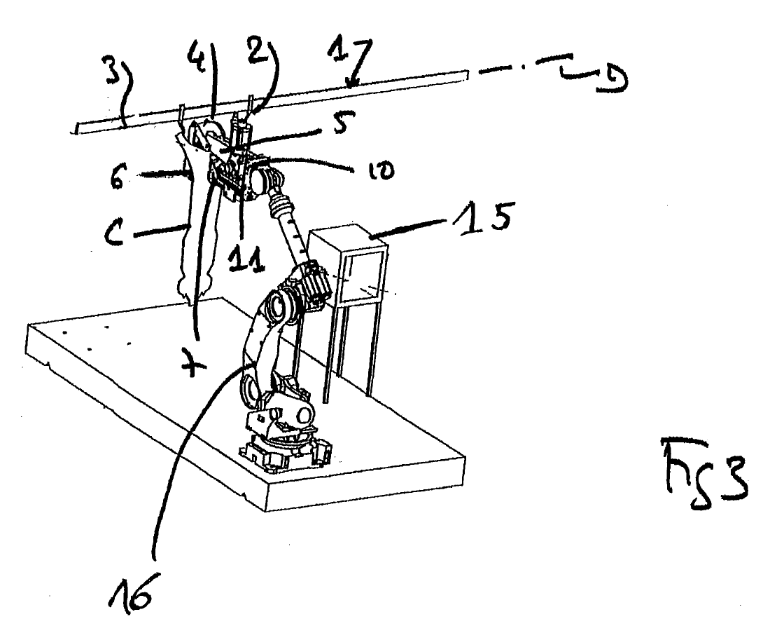

The third embodiment (FIG. 3) differs from the first in that a one and only robot 16 is provided and not two robots such as the robots 8, 9, the robot 16 providing the functions fulfilled by the two robots 8, 9. In this case, said robot 16 is laterally offset in relation to the displacement plane of the carcasses C, to enable the carcasses to pass therethrough. The robot 16 is located on the same side at the displacement plane of the carcasses C. Preferentially, it concerns the ventral side.

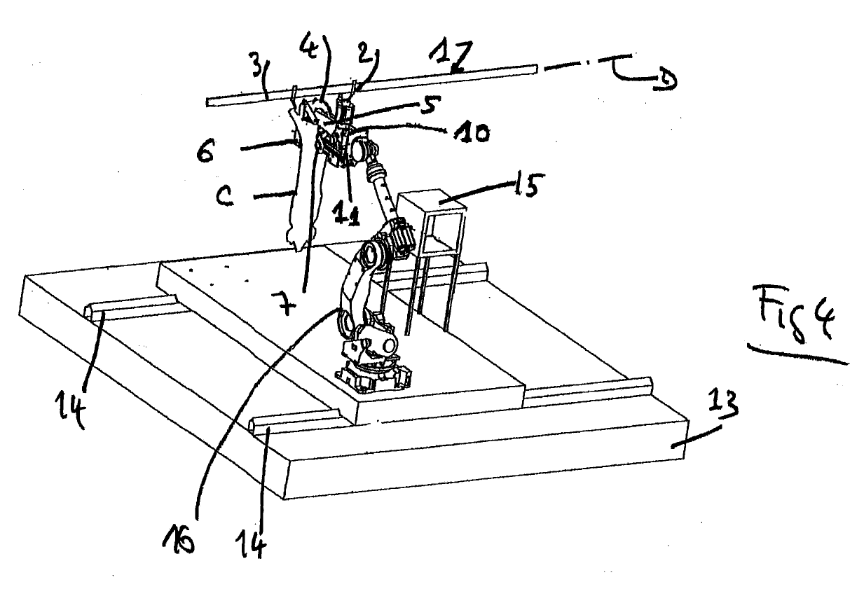

The fourth embodiment (FIG. 4) differs from the third in that the robot is not attached to the ground S, but supported by a table 13 horizontally slidably mounted parallel to the support means 1 of the carcasses C and to the line of displacement with the aid of rails 14 or equivalent attached to the ground S, as in the second embodiment. If necessary, the installation comprises means for detecting the presence and the proximity of a carcass C to be split.

The invention claimed is:

1. An installation for splitting hog carcasses or equivalent, the installation comprising:
support means for carcasses before the splitting, during the splitting, and after the splitting, comprising components for suspending the carcasses;
a splitting tool for carcasses, supported by a splitting head, suitable for being rendered operational and displaced in a splitting plane at least substantially vertical and median of the carcass during the splitting, arranged at least substantially perpendicular to a plane at least substantially vertical of relative displacement in translation of the carcasses at least before and after the splitting passing through the component for suspending the carcass during the splitting, the displacement plane of the carcasses and the component for suspending the carcasses defining a line of displacement of the carcasses at least substantially horizontal;
a dorsal support device and a ventral support device, opposite one another and located substantially on either side of the displacement plane of the carcasses, suitable for being displaced during the splitting in the splitting plane and for providing a fixed and predetermined relative displacement of the carcass during the splitting in relation to the splitting plane;
support means for the splitting head;
support means for the dorsal support device and support means for the ventral support device;
a motor operating the splitting tool in the splitting plane;
means for displacing the splitting head;
means for displacing the dorsal support device and means for displacing the ventral support device;
a controller controlling the motor for the splitting tool, means for displacing the splitting head, means for displacing the dorsal support device, means for displacing the ventral support device, in a coordinated way to provide splitting of the successive carcasses in the respective median planes thereof, according to successive splitting cycles;
at least one robot, suitable for producing an operational task in response to an instruction which is given to same, comprising a base and, assembled on same with at least one degree of rotation, a succession of arm terminated by a hand, hinged to one another and to which are associated driving means, the hand being suitable for being displaced according to a predetermined or predeterminable path, for transmitting a force, and to be equipped with a dedicated work device which:
(a) supporting at least one portion of the support means for the splitting head, of the support means for the dorsal support device and of the support means for the ventral support device; and
(b) constituting at least in part the means for displacing the means that same supports: a splitting head, a dorsal support device and ventral support device.

2. An installation according to claim 1, wherein the support means for the dorsal support device and the support means for the ventral support device are all supported by at least one robot constituting the means for displacing the splitting head, the dorsal support device and the ventral support device.

3. An installation according to claim 1, wherein the installation is free of a column forming the frame, a carriage supported by such a column and a driving and guiding component associated to such a carriage.

4. An installation according to claim 1, wherein the at least one robot includes:
a first robot supporting the support means for the splitting head and the support means for the ventral support device, and moreover constituting the means for displacing the splitting head and the ventral support device; and
a second robot supporting the support means for the dorsal support device, and moreover constituting the means for displacing the dorsal support device;
the two robots being located opposite one another, on either side of the displacement plane of the carcasses, and separated by a free space enabling the carcasses to pass between same.

5. An installation according to claim 1, wherein:
a single one of the at least one robot supports all of the support means for the splitting head, the support means for the dorsal support device and the support means for the ventral support device;
said single robot moreover constituting the means for displacing the splitting head, the dorsal support device and the ventral support device; and
said robot being laterally offset in relation to the displacement plane of the carcasses to enable the carcasses to pass therethrough.

6. An installation according to claim 1, wherein the robot is a six-axes robot.

7. An installation according to claim 1, wherein the at least one robot is stationarily mounted to a floor and the displacements take place at least substantially in the splitting plane forming at least substantially a median plane for the robot, and the controller is suitable for controlling the components for suspending the carcasses so that, during the splitting, they remain in the stationary state.

8. An installation according to claim 1, wherein the substantial horizontal displacements take place at least substantially in the splitting plane and a portion outside of same, and the controller is suitable for controlling the robot or robots and the components for suspending the carcasses so that, during the splitting, the latter are displaced in translation along the line of displacement and in the displacement plane of the carcasses, in synchronism with the robot such that the splitting head and the carcass are located in the splitting plane.

9. An installation according to claim 1, further comprising at least one table supporting the robot slidably mounted at least substantially horizontally at least substantially parallel to the line of displacement of the carcasses, the means for displacing the components for suspending the carcasses along the line of displacement of the carcasses and in the displacement plane of the carcasses, the controller being suitable for controlling in synchronism the components for suspending the carcasses and the table so that they remain opposite, without substantial offset parallel to the line of displacement of the carcasses, at least during the splitting.

10. An installation according to claim 1, further comprising at least one cleaning device wherein the robot can insert the means that they support in view of the cleaning thereof.

11. An installation according to claim 1, further comprising a deformable protector located adjacent a head of the robot.

12. An installation according to claim 1, wherein the dorsal support device and ventral support device are arranged at least substantially in the vicinity of the splitting plane and comprising a plurality of guiding components, such as rollers, spaced apart from one another at least substantially parallel to the line of displacement of the carcasses, and located on either side of the splitting plane, in the vicinity of the splitting tool.

13. An installation according to claim 1, wherein guiding components of the dorsal support device and ventral support device are arranged in a pair of components spaced apart from one another along a direction at least substantially vertical.

14. An installation according to claim 1, wherein the robot supports the splitting head and the splitting head supports the ventral support device located below its interface with the robot.

15. An installation according to claim 1, wherein the robot supports the splitting head and the ventral support device, located below the splitting head.

16. An installation according to claim 1, further comprising displacement means relating to translation over a short distance of the splitting head and of the ventral support device in relation to a line at least substantially horizontal located in the splitting plane, and the controller also acting on said displacement means.

17. An installation according to claim 1, further comprising mobile or releasable means for protecting the splitting tool so that the portion being able to interfere with the hams of the carcass is first rendered inoperable at the latest before the splitting tool interferes with the carcass and, then, rendered operational for splitting the carcass.

18. An installation according to claim 1, wherein the controller operably controls the motor for the splitting tool, means for displacing the splitting head, means for displacing the dorsal support device, and means for displacing the ventral support device, to provide either the total splitting or the partial splitting of the successive carcasses in the respective median planes thereof.

19. An installation according to claim 1, wherein the splitting tool includes a circular saw blade pivotably mounted about the axis thereof.

20. A carcass splitting machine having a splitting plane which is substantially vertical and substantially parallel to a direction of elongation of a carcass rail, the machine comprising:
at least one articulated robot having elongated coupled arms and at least six axes of movement;
a carcass splitting tool coupled to the robot at a location adjacent an end of the robot;
a first carcass support coupled to the robot at a location adjacent the end of the robot; and
a second carcass support operably located on an opposite side of the splitting plane from the ventral support;
the robot operably moving the splitting tool and at least the first carcass support in a substantially vertical carcass splitting direction; and
the second carcass support operably moving in the substantially vertical carcass splitting direction in synchronism and substantially aligned with the first support.

21. The machine of claim 20, further comprising a cleaning unit located in an offset position from the robot, the robot operably moving the splitting tool to the cleaning unit.

22. The machine of claim 21, wherein the cleaning unit includes a box raised above the ground.

23. The machine of claim 20, wherein the at least one articulated robot includes:
a first articulated robot on one side of the splitting plane moving the splitting tool and first carcass support; and
a second articulated robot on the other side of the splitting plane moving the second support.

24. The machine of claim 20, further comprising:
a set of rails horizontally elongated substantially parallel to the splitting plane; and
a member horizontally movable along the rails;
the at least one robot being mounted to and horizontally moving with the member during carcass splitting.

25. The machine of claim 20, wherein the at least one robot is a single robot and the second carcass support is coupled to and movable with the single robot.

26. The machine of claim 20, wherein the first carcass support includes a set of carcass-engaging rollers and the second carcass support includes a set of carcass-engaging rollers.

27. The machine of claim 20, wherein the robot moves the splitting tool to vertically split a hog carcass into substantially two separate halves along a spine of the carcass, the carcass being suspended by only its rear legs and horizontally moving along the carcass rail.

28. The machine of claim 20, wherein the robot varies the relative positioning of the splitting tool relative to at least one of the carcass supports at the American cut position.

29. A carcass splitting machine comprising:
a first articulated robot located on a front side;
a second articulated robot located on a back side;
a carcass splitting tool moved by the first robot during carcass splitting movement; and
a carcass engaging support moved by the second robot during the splitting movement.

30. The machine of claim 29, wherein the first robot moves the splitting tool and the second robot moves the support in a coordinated substantially vertical direction during splitting.

31. The machine of claim 29, further comprising a cleaning unit located in an offset position from the first robot, the first robot operably moving the splitting tool to the cleaning unit.

32. The machine of claim 29, wherein the support includes rollers.

33. The machine of claim 29, further comprising carcass engaging rollers coupled to and movable with the first robot.

34. The machine of claim 29, wherein the first robot moves the splitting tool to vertically split a hog carcass into substantially two separate halves along a spine of the carcass, the carcass being suspended by only its rear legs and horizontally moving along a carcass rail during the carcass splitting movement.

35. The machine of claim 29, further comprising:
a set of rails being horizontally elongated substantially parallel to the splitting plane; and
a member horizontally movable along the rails; and
at least one of the robots being mounted to and horizontally moving with the member during the carcass splitting movement.

36. A method of splitting a hog carcass, the method comprising:
(a) moving a suspended hog carcass along a carcass rail;
(b) automatically pivoting a first robotic arm about a base and automatically pivoting a second robotic arm relative to the first arm;
(c) automatically pivoting a splitting head relative to the second arm;
(d) automatically splitting the hog carcass along its spine through movement of the splitting head by the robotic arms; and
(e) automatically positioning a support against the carcass during splitting by moving the robotic arms.

37. The method of claim 36, further comprising:
(a) vertically splitting the hog carcass during horizontal movement of the carcass along the rail; and
(b) automatically moving rollers on an opposite side of the carcass from the support, by a second set of robotic arms, during the splitting operation.
